(19) United States
(12) Patent Application Publication
(10) Pub. No.: US 2009/0046449 A1
(43) Pub. Date: Feb. 19, 2009

(54) LED Street Lamp

(76) Inventor: Xuliang LI, Dongguan (CN)

Correspondence Address: SCIHEAD INTELLECTUAL PROPERTY LAW GROUP, LTD, Huihua Commercial & Trade Building, Suite 1508, 80 Xian Lie Zhong Road, Guangzhou, 51070, CN

(21) Appl. No.: 12/189,792

(22) Filed: Aug. 12, 2008

(30) Foreign Application Priority Data
Aug. 13, 2007 (CN) 200720122243.8

(51) Int. Cl. E01F 9/00; F21V 11/00

(52) U.S. Cl. 362/153.1; 362/240

(57) ABSTRACT

The present invention relates to a LED street lamp, and more particularly to LED street lamp which is easy to maintenance. The LED street lamp comprises street lamp pole, lamp body and LED bulbs, said lamp body is mounted on the top of said street lamp pole, said LED bulbs is mounted in said lamp body, wherein the LED street lamp further comprises Power supply adapter and constant current actuating device, said Power supply adapter is mounted at the bottom of said street lamp pole, said constant current actuating device is mounted in said lamp body. The LED street lamp involved in the present invention is easy to maintenance.

### BACKGROUND OF THE INVENTION

1. Field of the Invention

The present invention relates to a LED street lamp, and more particularly to a LED street lamp which is easy to be maintained.

2. Description of the Prior Art

Typically, the ordinary street lamp is high-pressure sodium lamp. In addition to the switch button, other parts of the street lamps are mounted on the top of the street lamps pole. Once the street lamp went wrong or needed maintenance, serviceman would be send to high place to maintain the street lamp by special crane or elevator. Maintenance is very difficult, long cycle and high costs. Compared with the high-pressure sodium lamp, LED Street lamp has good chroma, and needs no maintenance with a long service life. It is more energy-saving. In the traditional conception, equipment like power supply adapter are mounted in lamp body, therefore, although LED bulb has a long service life itself, the top of the LED street lamp still need maintenance just because of power supply adapter, the costs of maintenance is high and maintenance is discommodious. On the other hand, power supply adapter is calorifacient, so it adds to the burden of the lamp body's heat emanation. That then reduces the service life of the power supply adapter also.

### SUMMARY OF THE INVENTION

An object of this invention is to provide an LED street lamp which is effective heat emanation and easy to maintenance for overcoming the aforementioned disadvantage.

The present invention can be achieved by following technical solutions: An LED street lamp comprises street lamp pole, lamp body and LED bulbs, said lamp body is mounted on the top of said street lamp pole, said LED bulbs is mounted in said lamp body, wherein the LED street lamp further comprises Power supply Adapter and constant current actuating device, said Power supply Adapter is mounted at the bottom of said street lamp pole, said constant current actuating device is mounted in said lamp body.

An LED street lamp, wherein said LED bulbs compose umpty working module, every said working module is connected with an independent constant current actuating device.

An LED street lamp, wherein the LED street lamp further comprises an over heat thermostat mounted in said lamp body, said over heat thermostat is mounted between the fan-out of said Power supply Adapter and the input of constant current actuating device.

An LED street lamp, wherein the lamp body comprises a head portion, a middle portion and a tail portion; said head portion and one side of said middle portion are connected butt and butt, and the opposite side of said middle portion and said tail portion are connected the same; a first packing washer is provided between the head portion and the middle portion, and the head portion and the middle portion are secured by fasteners; a second packing washer is provided between the tail portion and the middle portion, and the tail portion and the middle portion are secured by fasteners; the middle portion is a kind of sectional material, it has the same cross section in the different position along its length direction, said sectional material consists of a basal plate, said basal plate is tabulate, said basal plate extends along the direction of the length of said sectional material, said basal plate has two sides: the right side and the wrong side; a side plate is respectively mounted on each of the two edges of said right side, there are some heat dissipation wings mounted on said wrong side; LED bulbs are mounted on a side of said heat conducting bottom-board, which form LED array board, printed circuit is mounted on said heat conducting bottom-board, the another side of said heat conducting bottom-board which has no LED bulb is clinged to said right side of said basal plate of middle portion of said lamp body; the LED street lamp also comprises quadratic optical lens, said quadratic optical lens is mounted on said lens bottom-board with bottom stand, said lens bottom-board is parallel to LED array board, every said LED bulb is corresponding to one said quadratic optical lens there are some support units which have the same height mounted on the side of said lens bottom-board which faces to LED array board, said support units are withstand said heat conducting bottom-board, said lens bottom-board and said heat conducting bottom-board are connected to the right side of said basal plate with the screw; first cross member is mounted on said head portion, said first beam is mounted on the end of said head portion of said bomb body which is withstand with said middle portion; second cross member is mounted on the tail portion, said second cross member is mounted on the end on said tail portion 103 of said bomb body which is withstand with said middle portion; said first cross member, second cross member, said side plate which is on the two edge of the right side of said middle portion, and the right side of said middle portion define a enclosure together, the right side of said middle portion form the bottom of said enclosure, said first cross member, second cross member, and said two side plate which is mounted on the two edge of the right side of said middle portion form the four walls of said enclosure, a step used to place lamp-chimney is mounted on the other end of the four walls of the enclosure which is far from the bottom; a length of tube is mounted on said head portion, the axes of said tube is vertical to said first cross member, a outlet hole leading into said tube is mounted on said first cross member, a threaded hole running through the tube wall is mounted on the side wall of said tube, said head portion, middle portion, and tail portion are all made of heat-conducting property, said LED street lamp also comprises lamp-chimney, said lamp-chimney is mounted on said step, packing washer is mounted between said lamp-chimney and lamp body, LED array board comprises several LED subsidiary array boards, a team of LED lamp are mounted on every LED subsidiary array board, every LED subsidiary array board is connected on the right side of said base board of middle portion 102 with fastener, correspondingly, lens bottom-board also comprises several subsidiary lens bottom-boards, a team of quadratic optical lenses is mounted on every subsidiary lens bottom-board, every subsidiary lens bottom-board is connected on the right side of said base board of middle portion with fastener; said constant current actuating device is mounted on the middle portion closer to the head portion of the lamp body, the heat-actuated device of the over heat thermostat is mounted on the heat conducting bottom-board.

The theoretic service life of LED bulb is more than one hundred thousands hours, and constant current actuating device work in low-voltage, therefore, in the life cycle of LED street lamp, LED bulb and constant current actuating device would not went wrong almost. In the present invention, the LED bulb and the constant current actuating device are mounted in the lamp body which is on the top of the lamp pole, the Power supply Adapter is mounted at the bottom of the street lamp pole. We can mount a chest at the bottom of the street lamp pole, the Power supply Adapter is mounted in the chest, when something is wrong, we can open the chest and then maintain the Power supply Adapter; Compared with traditional technique, maintenance become more convenient and fast, cost of maintenance is lower also. Moreover, there are advantages as following: 1. Power supply adapter is calorifacient, so it is mounted separately to reduce the burden of the lamp body's heat emanation, thereby prolong the service life of the LED street lamp. 2. Accordingly, the service life of the power supply adapter is prolonged also. 3. Compared with the LED bulb, the service life of the power supply adapter is shorter, so it is more convenient for maintenance.

### BRIEF DESCRIPTION OF THE DRAWINGS

FIG. 1 is function block diagram of a first embodiment of the invention;

FIG. 2 is a three-dimensional view of the first embodiment of the invention;

FIG. 3 is an enlarged view of A-A in FIG. 2;

FIG. 4 is an enlarged view of B-B in FIG. 2;

FIG. 5 is a sectional view of lamp body in 1^{st} embodiment of the invention.

### DETAILDED DESCRIPTION OF THE INVENTION

The present invention now could be described more fully hereinafter with reference to the accompanying drawings.

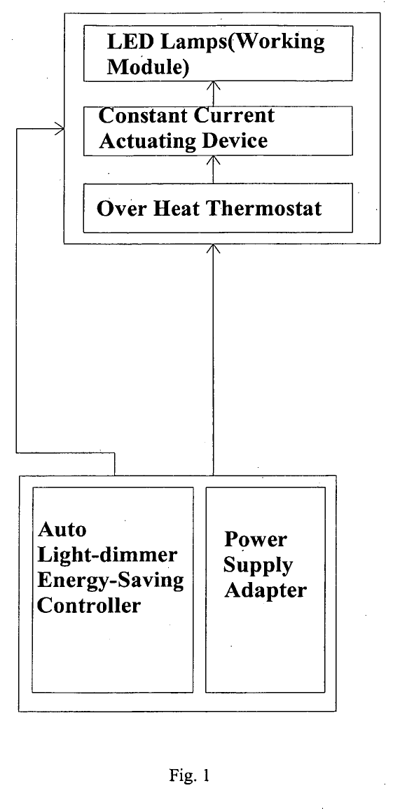

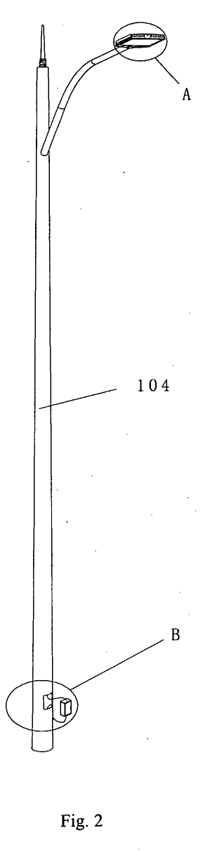

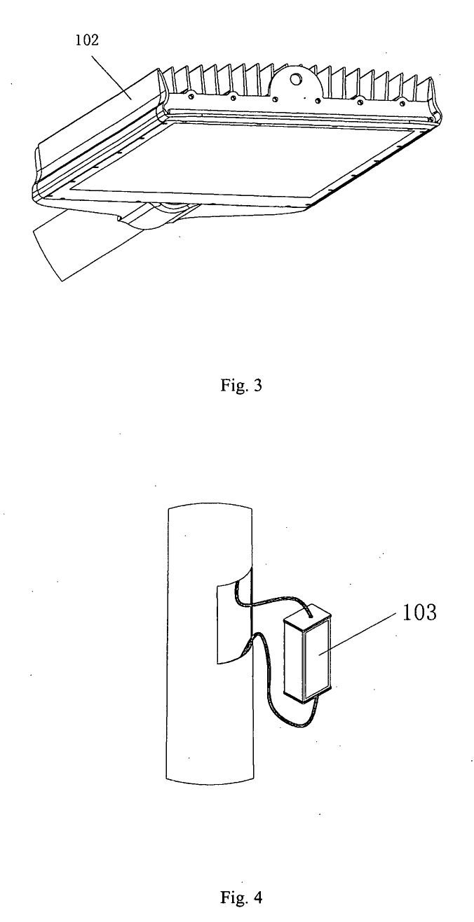

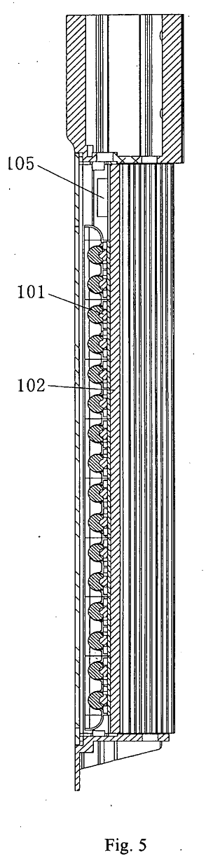

A first embodiment of the invention is a LED street lamp. Referring to FIGS. 1-5, the LED street lamp comprises street lamp pole 104, lamp body 102 and LED bulbs 101, said lamp body 102 is mounted on the top of said street lamp pole 104, said LED bulbs 101 is mounted in said lamp body 102, wherein the LED street lamp further comprises Power supply adapter 103 and constant current actuating device 105, said Power supply adapter 103 is mounted at the bottom of said street lamp pole 104, said constant current actuating device 105 is mounted in said lamp body. The lamp body 102 comprises a head portion, a middle portion and a tail portion; said head portion and one side of said middle portion are connected butt and butt, and the opposite side of said middle portion and said tail portion are connected the same; A first packing washer is provided between the head portion and the middle portion, and the head portion and the middle portion are connected by screw; A second packing washer is provided between the tail portion and the middle portion, and the tail portion and the middle portion are connected by screw; the middle portion is a kind of sectional material, it has the same cross section in the different position along its length direction, said sectional material consists of a basal plate, said basal plate is tabulate, said basal plate extends along the direction of the length of said sectional material, said basal plate has two sides: the right side and the wrong side; a side plate is respectively mounted on each of the two edges of said right side, there are some heat dissipation wings mounted on said wrong side; LED bulbs are mounted on a side of said heat conducting bottom-board, which form LED array board, printed circuit is mounted on said heat conducting bottom-board, the other side of said heat conducting bottom-board which has no LED bulb is clinged to said right side of said basal plate of middle portion of said lamp body; the LED street lamp also comprises quadratic optical tens, said quadratic optical lens is mounted on said lens bottom-board with bottom stand, said lens bottom-board is parallel to LED array board, every said LED bulb is corresponding to one said quadratic optical lens, there are some support units which have the same height mounted on the side of said lens bottom-board which faces to LED array board, said support units are cylinder in this embodiment, there is a through hole mounted in the hub of said cylinder, there is also a hole on the part of said heat conducting bottom-board which is opposite to the hole of said cylinder, the above-mentioned two holes are used for setting the screw. There is a counterbore mounted on the part which is opposite to said support unit of the other side of said lens bottom-board, it is used for immersing the head of the screw said support units are withstand said heat conducting bottom-board and said lens bottom-board, said heat conducting bottom-board is connected the right side of said basal plate with the screw; first cross member is mounted on said head portion, said first beam is mounted on the end of said head portion of said lamp body which is withstand with said middle portion; second cross member is mounted on the tail portion, said second cross member is mounted on the end on said tail portion of said lamp body which is withstand with said middle portion; said first cross member, second cross member, said side plate which is on the two edge of the right side of said middle portion, and the right side of said middle portion define a enclosure together, the right side of said middle portion form the bottom of said enclosure, said first cross member, second cross member, and said two side plate which is mounted on the two edge of the right side of said middle portion form the four walls of said enclosure, a step used to place lamp-chimney is mounted on the other end of the four walls of the enclosure which is far from the bottom. A length of tube is mounted on said head portion, the axes of said tube is vertical to said first cross member, a outlet hole leading into said tube is mounted on said first cross member, a threaded hole running through the tube wall is mounted on the side wall of said tube, which is used to lock the LED street lamp on the lampstandard, in this embodiment, protuberant arris is mounted on the ektexine of said tube, said protuberant is mounted along the axial, said threaded hole is mounted on said protuberant. Said head portion, middle portion, tail portion are all aluminum which has good heat-conducting property. Said LED street lamp also comprises lamp-chimney, said lamp-chimney is mounted on said step, packing washer is mounted between said lamp-chimney and lamp body. LED array board comprises several LED subsidiary array board, a team of LED lamp 101 are mounted on every LED subsidiary array board, and every LED subsidiary array board is connected on the right side of said base board of middle portion with screw. The LED lamps mounted on every LED subsidiary array board compose a LED working module; correspondingly, lens bottom-board also comprises several subsidiary lens bottom-boards, a team of quadratic optical lenses is mounted on every subsidiary lens bottom-board, every subsidiary lens bottom-board is connected on the right side of said base board of middle portion with screw. The LED lamps 101 mounted on every LED subsidiary array board compose a LED working module, LED street lamp also comprises constant current actuating device 105, said constant current actuating device 105 is mounted in the close enclosure formed by the lamp body and lamp-chimney, several teams of unattended constant current actuating devices 105 are mounted on the end close to said head portion, the fan-outs of every constant current actuating device are connected with the corresponding LED subsidiary array board by the lead, said constant current actuating device is used to supply power for the corresponding LED working module, said every team constant current actuating device have a common input end, said input end is connected to power supply adapter by the lead. Said constant current actuating device is mounted on the middle portion of the lamp body closer to the head portion, the heat-actuated device of the over heat thermostat is mounted on the heat conducting bottom-board, said over heat thermostat is mounted between the fan-out of said Power supply adapter and the input of constant current actuating device.

The second embodiment of this invention is also a LED street lamp, Compared with the first embodiment of this invention, a difference is the middle portion of the lamp body is longer; correspondingly, the head portion and the tail portion are connected tensely by bolt. The bolt is mounted in the gap between the heat dissipation wings. Another difference is two LED subsidiary array board are connected to every constant current actuating device, this constant current actuating device is used to supply power for two LED working module.

In the aforesaid two embodiments, constant current actuating device and LED lamp are mounted in lamp body on the top of the street lamp pole; power supply adapter is mounted at the bottom of the street lamp pole. Therefore, maintenance of power supply adapter become convenient, compared with traditional technique, maintenance is easier.

What is claimed is:

1. An LED street lamp comprising:
street lamp pole, lamp body and LED bulbs, said lamp body is mounted on the top of said street lamp pole, said LED bulbs is mounted in said lamp body, wherein the LED street lamp further comprises Power supply adapter and constant current actuating device, said Power supply adapter is mounted at the bottom of said street lamp pole, said constant current actuating device is mounted in said lamp body.

2. The LED street lamp according to claim 1, wherein said LED bulbs compose umpty working module, every said working module is connected with an independent constant current actuating device.

3. The LED street lamp according to claim 1, wherein The LED street lamp further comprises an over heat thermostat mounted in said lamp body, said over heat thermostat is mounted between the fan-out of said Power supply adapter and the input of constant current actuating device.

4. The LED street lamp according to claim 3, wherein the lamp body comprises a head portion, a middle portion and a tail portion; said head portion and one side of said middle portion are connected butt and butt, and the opposite side of said middle portion and said tail portion are connected the same; a first packing washer is provided between the head portion and the middle portion, and the head portion and the middle portion are secured by fasteners; a second packing washer is provided between the tail portion and the middle portion, and the tail portion and the middle portion are secured by fasteners;
the middle portion is a kind of sectional material, it has the same cross section in the different position along its length direction, said sectional material consists of a basal plate, said basal plate is tabulate, said basal plate extends along the direction of the length of said sectional material, said basal plate has two sides: the right side and the wrong side; a side plate is respectively mounted on each of the two edges of said right side, there are some heat dissipation wings mounted on said wrong side;
LED bulbs are mounted on a side of heat conducting bottom-board, which form LED array board, printed circuit is mounted on said heat conducting bottom-board, the another side of said heat conducting bottom-board which has no LED bulb is clinged to said right side of said basal plate of middle portion of said lamp body;
the LED street lamp also comprises quadratic optical lens, said quadratic optical lens is mounted on said lens bottom-board with bottom stand, said lens bottom-board is parallel to LED array board, every said LED bulb is corresponding to one said quadratic optical lens, there are some support units which have the same height mounted on the side of said lens bottom-board which faces to LED array board, said support units are withstand said heat conducting bottom-board, said lens bottom-board and said heat conducting bottom-board are connected to the right side of said basal plate with the fastener;
first cross member is mounted on said head portion, said first beam is mounted on the end of said head portion of said lamp body which is withstand with said middle portion; second cross member is mounted on the tail portion, said second cross member is mounted on the end on said tail portion of said lamp body which is withstand with said middle portion; said first cross member, second cross member, said side plate which is on the two edge of the right side of said middle portion, and the right side of said middle portion define a enclosure together, the right side of said middle portion form the bottom of said enclosure, said first cross member, second cross member, and said two side plate which is mounted on the two edge of the right side of said middle portion form the four walls of said enclosure, a step used to place lamp-chimney is mounted on the other end of the four walls of the enclosure which is far from the bottom; a length of tube is mounted on said head portion, the axes of said tube is vertical to said first cross member, a outlet hole leading into said tube is mounted on said first cross member, a threaded hole running through the tube wall is mounted on the side wall of said tube;
said head portion, middle portion and tail portion are all made of heat-conducting material;
said LED street lamp also comprises lamp-chimney, said lamp-chimney is mounted on said step, packing washer is mounted between said lamp-chimney and lamp body; LED array board comprises several LED subsidiary array boards, a team of LED lamp are mounted on every LED subsidiary array board, every LED subsidiary array board is connected on the right side of said basal board of middle portion with fastener;
correspondingly, lens bottom-board also comprises several subsidiary lens bottom-boards, a team of quadratic optical lenses is mounted on every subsidiary lens bottom-board, every subsidiary lens bottom-board is connected on the right side of said basal board of middle portion with fastener; said constant current actuating device is mounted on the middle portion closer to the head portion of the lamp body, the heat-actuated device of the over heat thermostat is mounted on the heat conducting bottom-board.
